(19) United States
(12) Patent Application Publication
(10) Pub. No.: US 2019/0234085 A1
(43) Pub. Date: Aug. 1, 2019

(54) METHOD AND DEVICE FOR CONTROLLING THE MOVEMENT OF A CONCRETE-DISTRIBUTING BOOM

(71) Applicant: Putzmeister Engineering GmbH, Aichtal (DE)

(72) Inventor: Tobias Huth, Nürtingen (DE)

(21) Appl. No.: 16/383,141

(22) Filed: Apr. 12, 2019

Related U.S. Application Data
(63) Continuation of application No. PCT/EP2017/076224, filed on Oct. 13, 2017.

(30) Foreign Application Priority Data
Oct. 14, 2016 (EP) 16193888.1

(51) Int. Cl. E04G 21/04; G05D 3/12

(52) U.S. Cl. CPC E04G 21/0454; E04G 21/0436; G05D 3/12; E04G 21/0463

(57) ABSTRACT

This disclosure relates to a method and a device for controlling the movement of a concrete-distributing boom, the boom base of which is mounted on a slewing gear so as to be rotatable about a vertical axis of rotation, the slewing gear being actuated by means of a rotary drive and, if necessary, a brake in order to bring the boom into a desired angular position, it being possible for an undesired natural oscillation of the boom to occur in the horizontal direction upon accelerating and/or decelerating the boom. According to this disclosure, it is proposed that the rotary drive be temporarily switched to a freewheel mode in the range of at least one peak of oscillation of the natural oscillation, so that the slewing gear is freely movable and the natural oscillation is reduced.

### RELATED APPLICATIONS

This application is a continuation of PCT/EP2017/076224, filed Oct. 13, 2017, which claims priority to EP 16193888.1, filed Oct. 14, 2016, both of which are hereby incorporated herein by reference in their entirety.

### BACKGROUND

This disclosure relates to a method for controlling the movement of a concrete-distributing boom, the boom base of which is mounted on a slewing gear so as to be rotatable about a vertical axis of rotation, the slewing gear being actuated by means of a rotary drive and, if necessary, a brake in order to bring the boom into a desired angular position, it being possible for an undesired natural oscillation of the boom to occur in the horizontal direction upon acceleration and/or deceleration. This disclosure further relates to a device that is configured for carrying out such a method.

In currently used truck-mounted concrete pumps, joystick controls with which the operator specifies a change in movement that is dependent on the joystick deflection are used to rotate the concrete-distributing boom. At the beginning of the rotational movement, the boom tip initially remains in its original position due to inertia while the slewing gear is already rotating. The distribution boom is thus prestressed. It is only with a certain time delay that the boom tip abruptly begins to move. This leads to unwanted whipping oscillations of the entire distribution boom. The substructure can also be caused to oscillate. The same behavior is observed during braking. Such oscillations increase as components become ever lighter and hence usually more flexible. This, in turn, makes it difficult to work in the vicinity of such cantilever structures and increases the risk, especially for the operator of the end hose at the pouring site.

### SUMMARY

Against this background, this disclosure further improves the methods and devices that are known in the prior art and reduces or prevents unwanted boom oscillations that are induced by startup/braking operations.

This disclosure is based on the idea of cleverly exploiting the change of potential and kinetic energy during changes in movement of the boom structure in order to control the boom tip. Accordingly, it is proposed in terms of the method that the rotary drive be temporarily switched to a freewheel mode in the range of at least one amplitude maximum of the natural oscillation, so that the slewing gear is relieved of torque or transmits no torque and is freely movable for a predetermined period of time. Self-oscillations of the boom can thus be largely reduced without extensive mechanical effort. Such motion control can be employed in all acceleration and braking operations independently of the current state of motion. A hydraulic or an electric rotary drive is expediently used.

In one advantageous embodiment of the control sequence, the switch-on time for the freewheel mode is determined on the basis of a measured value that is detected during the rotational movement.

Another improvement is achieved in this context by virtue of the fact that the rotary drive is switched to freewheel mode at the moment an extreme value of the torque being applied to the slewing gear occurs. At this point, the oscillatory system has its maximum potential energy and thus its minimum kinetic energy.

One sensor-controlled variant makes a provision that the torque on the slewing gear is detected sensorially by means of a torque transducer, particularly by means of a strain measurement (using strain gauges, for example).

In connection with a rotary drive, which is instantiated by a hydraulic motor, it is particularly advantageous if the switch-on time for the freewheel mode is determined from the course of a sensorially detected hydraulic pressure being applied to the hydraulic motor or a quantity derived therefrom.

Potential energy can be selectively converted by hydraulically short-circuiting the hydraulic motor for the freewheel mode, preferably by means of a switching valve, by connecting its pressure ports via an unrestricted hydraulic line.

Another advantageous variant makes a provision that the freewheel mode is triggered in a time-controlled manner according to a control signal for accelerating and/or decelerating the boom.

In the case of a timed sequence, it is particularly advantageous if the freewheel mode is switched on based on the natural oscillation of the boom, preferably upon lapsing of a quarter of the natural oscillation period after the control signal.

In order to prevent a “running-away” of the boom, the freewheel mode should be deactivated after a predetermined period of time after being switched on. Such a measure is also advantageous for safety reasons.

In this case, it is possible for the duration of freewheeling to be determined empirically or mathematically from known boom data, thereby minimizing a natural oscillation of the boom.

In any case, it should be ensured that the brake remains released or relieved of pressure at least for the duration of freewheeling.

Advantageously, the rotary drive is relieved of torque during the intended duration of freewheeling such that no braking or driving torque is transferred to the slewing gear.

This disclosure also relates to a device for controlling the movement of a concrete-distributing boom, with a concrete-distributing boom, a slewing gear on the boom base of the concrete-distributing boom that is mounted so as to be rotatable about a vertical axis of rotation, wherein the slewing gear is actuatable by means of a rotary drive and, if necessary, a brake; wherein an undesirable natural oscillation of the boom can occur in the horizontal direction during acceleration and/or deceleration; and wherein the rotary drive can be switched temporarily into a freewheel mode in the range of at least one peak of oscillation of the natural oscillation of the boom so that the slewing gear is freely movable during freewheeling and the oscillation of the boom is minimized. It is in this way that the advantages listed at the outset in connection with a controlling method are achieved.

An especially preferred embodiment makes a provision that the rotary drive is instantiated by a hydraulic motor and that the hydraulic motor is hydraulically short-circuited for the freewheel mode, preferably by means of a switching valve, by connecting its pressure ports.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a symbolic representation of a concrete-distributing boom on a truck-mounted concrete pump;

FIG. 2 shows a block diagram of a slewing gear control for the concrete-distributing boom;

FIG. 3 shows various timing diagrams of the control sequence; and

FIG. 4 shows a comparison of the boom oscillation for the motion control according to this disclosure and for a conventional motion control.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

As used in this specification and claims, the terms “horizontal” and “vertical” and similar terms are generally used herein to establish positions of individual components relative to one another rather than an absolute angular position in space. Further, regardless of the reference frame, in this disclosure terms such as “vertical,” “parallel,” “horizontal,” “right angle,” “rectangular” and the like are not used to connote exact mathematical orientations or geometries, unless explicitly stated, but are instead used as terms of approximation. With this understanding, the term “vertical,” for example, certainly includes a structure that is positioned exactly 90 degrees from horizontal, but should generally be understood as meaning positioned up and down rather than side to side. Other terms used herein to connote orientation, position or shape should be similarly interpreted. Further, it shall be understood that various structural terms used throughout this disclosure and claims should not receive a singular interpretation unless it is made explicit herein. That is, all structural terms used herein should be interpreted as “one or more” or “at least one.”

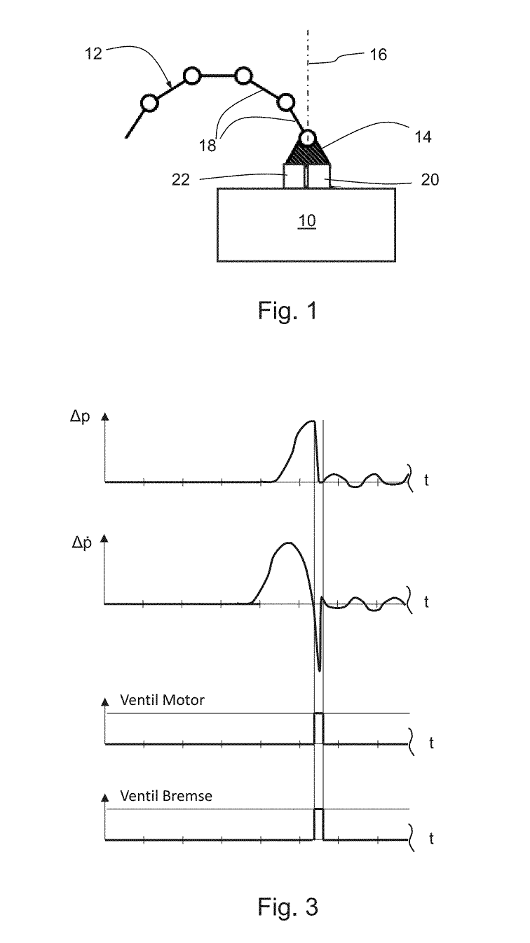

FIG. 1 represents a truck-mounted concrete pump 10 with a concrete-distributing boom 12 that carries a concrete line (not shown) and can be rotated at its base about a vertical axis 16 by means of a slewing gear 14 and is composed of a plurality of boom arms 18 that are connected to one another and to the slewing gear via joints with horizontal axes of rotation. Hydraulic cylinders (not shown) are associated with the joints as pivot drives, whereas the slewing gear 14 is driven by a hydraulic motor 20 and can be braked by means of a brake 22, as will be explained in more detail below. The boom 12 can thus be moved into a desired rotational or angular position, while the radial distance of the boom tip from the vertical axis 16 can be varied through swiveling movement of the joints in order to deploy the concrete that is being conveyed via the concrete line at the worksite.

During conventional acceleration (both starting and braking) of the boom 12, undesirable oscillations occur in the horizontal direction about the vertical axis 16. The cause of these oscillations lies in the low spring stiffness (and associated small natural frequencies) on the one hand and in the low overall attenuation of the boom 12 on the other hand. This can cause large oscillation amplitudes that decay only slowly. Such oscillations can be largely suppressed by a slewing gear control as described below.

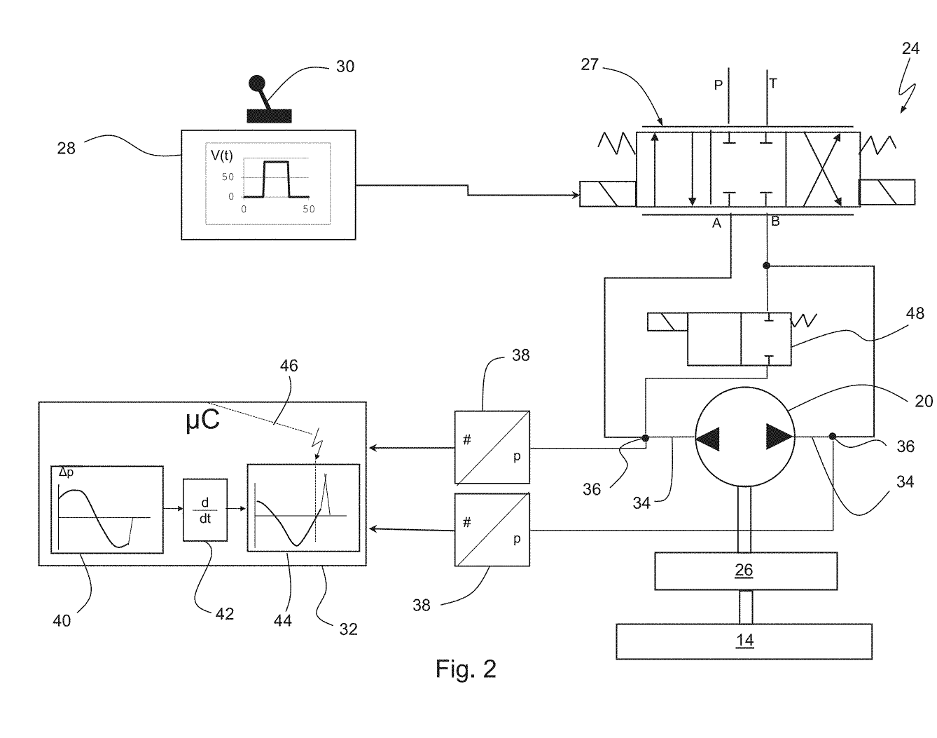

FIG. 2 shows a block diagram of a computer-aided control device (also referred to as “controller”) 24 for the rotary drive 20 that is embodied as a hydraulic motor and coupled with the slewing gear 14 via a reduction gear 26. The control device 24 comprises an electrically controlled proportional directional control valve 27 that can be controlled by an operator by means of an input device 28. This can be done by manually setting a target speed by swiveling a joystick 30. In the open positions of the proportional valve 27 that deviate from the center position, the pressure oil outlets A and B of the proportional valve 27 can be switched in a direction-dependent manner to the rotary drive 20 with constant transition of the valve opening. In this way, the rotational speed is specified in a time-dependent manner according to amount and direction.

Moreover, the control device 24 has a microcontroller 32 for the oscillation-minimizing activation of a freewheel mode of the rotary drive 20. A pressure sensor 36 is provided for this purpose at each of the two pressure ports 34 of the rotary drive 20 that supplies a digital, time-dependently detectable pressure signal 40 to the microcontroller 32 via a downstream analog-to-digital converter 38. This contains a differentiator 42 in order to generate a time-derived profile 44 of the pressure difference Ap from the pressure difference signal 40.

The microcontroller 32 has a switching stage 46 that outputs an electrical switching signal to the control input of a switching valve 48 that is embodied as a 2/2-way valve. This blocks the flow path in its spring-reset basic position and releases the flow path in both directions in its electrically actuated on position, so that the pressure ports of the rotary drive 20 are interconnected. Through this hydraulic short-circuiting, the rotary drive 20 is switched to a freewheel mode in which it transfers no torque and is thus freely movable.

In general, a gearbox can also be used as part of the rotary drive 20 in which the transmission of mechanical power from its input to its output can be switched such that no power is transmitted for the intended duration of freewheeling. A switchable mechanical coupling—e.g., a multiple-disc clutch—can be used for this purpose, for example. In the case of an electric rotary drive, it is also conceivable to electrically short-circuit the motor by connecting the poles.

Something that all manifestations have in common is that the occurrence or transfer of a torque due to the movement of the engine is prevented so that the output rotates freely.

FIG. 3 illustrates the control sequence for a low-oscillation acceleration of the boom 12. Upon acceleration, its mass inertia leads to a prestressing of the slewing gear 14 that is reflected in an increase in the differential pressure signal 40. The extreme value of the differential pressure Ap occurs at the time of the zero crossing of the time-derived signal 44. At this time, the valve 48 is switched to flow, so that the rotary actuator 20 is relieved of torque and thus freely movable. As shown in the third diagram, the valve 48 is blocked again after a predetermined period of time, resulting in a deactivation of the freewheel mode. In parallel, the brake 22 is released for the duration of freewheeling (lower diagram in FIG. 3). The duration of activation can be determined empirically or experimentally for a given boom configuration so that any oscillations that occur are minimized.

The process described can also be repeated analogously when the boom 12 is being decelerated. Instead of a differential pressure, the torque applied to the slewing gear 14 can be detected by means of strain gauges, for example, in order to derive an analog control sequence therefrom.

It is also conceivable for the freewheel mode to be triggered in a time-controlled manner at a time interval according to a drive signal triggered by the joystick 30. For the time-controlled variant, the natural frequency should be known. The duration between the start of acceleration or braking and the time at which the rotary drive 20 is switched to torque-free should correspond exactly to ¼ of the natural oscillation duration. This variant can be realized without additional sensors on the slewing gear 14. However, suitable boom sensors, particularly for the angular position of the boom arms 18, should be present in order to determine the natural frequency with the required accuracy.

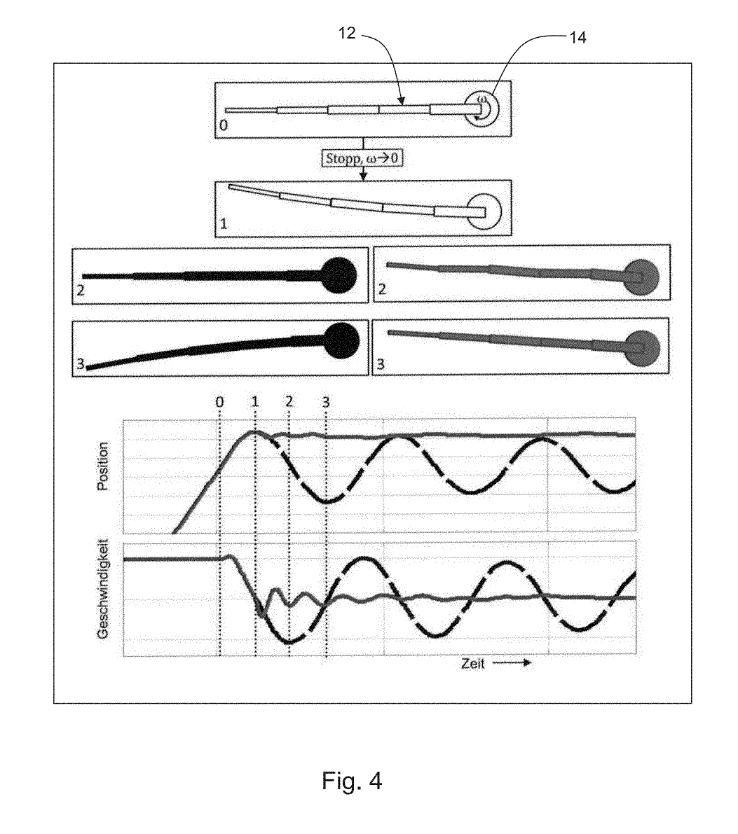

The oscillation-optimized control is further illustrated in FIG. 4 using the example of stopping the movement of the boom. The rotary drive 20 is stopped from a steady movement (time 0 in a vertical plan view of the boom 12). In the state of maximum potential energy (time 1), the prestressed slewing gear 14 is manipulated in such a way that the basis of this energy state is eliminated and the oscillatory system is itself relaxed by the freewheeling (time 2 in FIG. 4, right side). After that, the boom 12 is practically still (time 3 in FIG. 4, right side). The rotary drive 20 can then be blocked again.

In the implementation of the circuitry, this means that the rotary drive 20 is selectively switched to freewheel mode when the boom 12 is standing still in or reversing its oscillation. In conventional boom control, the boom overshoots due to a steep braking curve, as is shown for times 2 and 3 to the left in FIG. 4. Accordingly, the two lower timing diagrams show the time course of the position and speed of the boom tip for the inventive low-oscillation motion control (solid lines) in comparison to a conventional braking curve (broken lines) that leads to unwanted oscillations, with time points 0 to 3 being marked here as well.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A method for controlling the movement of a concrete-distributing boom for which undesired natural oscillation of the boom can occur in the horizontal direction upon accelerating and/or decelerating the boom, the method comprising:
(a) providing a slewing gear on which a boom base is rotatably mounted and rotatable about a vertical axis of rotation;
(b) actuating the slewing gear using a rotary drive and, when necessary, actuating a brake to thereby bring the boom into a desired angular position; and
(c) temporarily switching the rotary drive to a freewheel mode in the range of at least one oscillation maximum of the natural oscillation, whereby the slewing gear is freely movable and the natural oscillation is reduced, and the rotary drive is relieved of torque during freewheeling such that no braking or driving torque is transferred to the slewing gear.

2. The method as set forth in claim 1, wherein the switch-on time for the freewheel mode is determined on the basis of a measured value that is detected during the rotational movement.

3. The method as set forth in claim 1, comprising switching the rotary drive to freewheel mode at the moment an extreme value of the torque being applied to the slewing gear occurs.

4. The method as set forth claim 1, comprising detecting the torque on the slewing gear with a torque transducer.

5. The method as set forth in claim 4, wherein the detection comprises a strain measurement.

6. The method as set forth in claim 1, wherein the rotary drive comprises a hydraulic motor and step (b) comprises actuating the slewing gear with the hydraulic motor.

7. The method as set forth in claim 6, wherein the switch-on time for the freewheel mode is determined from the course of detected hydraulic pressure applied to the hydraulic motor or a quantity derived therefrom.

8. The method as set forth in claim 6, wherein the hydraulic motor is hydraulically short-circuited for the freewheel mode

9. The method as set forth in claim 8, wherein the short-circuiting is done by connecting pressure ports of a switching valve.

10. The method as set forth in claim 1, wherein the freewheel mode is triggered in a time-controlled manner after a control signal for accelerating and/or decelerating the boom.

11. The method as set forth in claim 10, wherein the freewheel mode is switched on based on the lapsing of a quarter of the natural oscillation period after the control signal.

12. The method as set forth in claim 1, comprising deactivating the freewheel mode after a predetermined period of time after being switched on.

13. The method as set forth in claim 12, wherein the duration of the freewheel mode is determined empirically or mathematically such that the natural oscillation of the boom is minimized.

14. The method as set forth in claim 1, wherein the brake remains released at least for the duration of freewheeling.

15. A device for controlling the movement of a concrete-distributing boom for which undesired natural oscillation of the boom can occur in the horizontal direction upon accelerating and/or decelerating the boom, the device comprising:
a slewing gear on which a boom base is rotatably mounted and rotatable about a vertical axis of rotation;
a rotary drive configured to actuate the slewing gear, the rotary drive comprising a hydraulic motor with pressure ports, the hydraulic motor configured to be short-circuited by connecting the pressure ports to initiate a freewheel mode;
a brake configured to bring the boom into a desired angular position; and
a controller configured to connect the pressure ports and thereby temporarily switch the rotary drive to a freewheel mode in the range of at least one oscillation maximum of the natural oscillation, whereby the slewing gear is freely movable and the natural oscillation is reduced, and the rotary drive is relieved of torque during freewheeling such that no braking or driving torque is transferred to the slewing gear.

16. The device as set forth in claim 15, further comprising a switching valve configured to connect the pressure ports and thereby hydraulically short-circuit the hydraulic motor for the freewheel mode.
